(19) United States
(12) Patent Application Publication
(10) Pub. No.: US 2026/0158952 A1
(43) Pub. Date: Jun. 11, 2026

(54) MOVABLE APPARATUS AND METHOD FOR CHARGING MOBILITY APPARATUS

(71) Applicants: Hyundai Motor Company, Seoul (KR); Kia Corporation, Seoul (KR)

(72) Inventors: Jae Hak KIM, Hwaseong-Si (KR); Jun Ki CHOI, Hwaseong-Si (KR); Su Jin SEOK, Hwaseong-Si (KR); Kyeong Uk LEE, Hwaseong-Si (KR)

(21) Appl. No.: 19/278,079

(22) Filed: Jul. 23, 2025

(30) Foreign Application Priority Data
Dec. 11, 2024 (KR) 10-2024-0183912

(51) Int. Cl. B60L 53/36; B60L 53/16; B60L 53/18; B60L 53/302; B60L 53/37

(52) U.S. Cl. CPC B60L 53/36; B60L 53/16; B60L 53/18; B60L 53/302; B60L 53/37

(57) ABSTRACT

The present disclosure relates to a movable apparatus and a method for charging a mobility apparatus that may automatically charge, regardless of a position and an installation height of a charging socket in the mobility apparatus, thereby reducing labor of a worker. The apparatus may include a mobile robot capable of autonomous driving, wherein a charging cable is connected to one side of the mobile robot; a robot arm installed on the mobile robot, wherein the robot arm comprises an end effector; and a charging connector mounted on the end effector and electrically connected to the charging cable.

### CROSS-REFERENCE TO RELATED APPLICATION(S)

This application claims priority to Korean Patent Application No. 10-2024-0183912, filed on Dec. 11, 2024, in the Korean Intellectual Property Office, the disclosure of which is incorporated herein by reference in its entirety.

### TECHNICAL FIELD

The present disclosure relates to a movable apparatus and more specifically to an apparatus and method for charging a mobility apparatus.

### BACKGROUND

For example, a mobility apparatus, such as electric vertical takeoff and landing (eVTOL) aircraft, may be used as urban air mobility (UAM), which is an air transportation means in an urban environment. Such an eVTOL aircraft may acquire power through a battery and a motor in order to minimize air and noise pollution in an urban environment.

Because of limitations such as a heavy weight of the aircraft body compared to a land-based electric vehicle, an energy density limit of a commercialized high-voltage battery, a large amount of output required for vertical takeoff and landing and transition flight, or the like, repeated charging of a battery may be required in the eVTOL aircraft, before and after flight.

In the eVTOL aircraft, a charging socket for charging of the battery may be located on a wing, a wing spar, a nacelle, or the like, but these locations may be difficult for service personnel to reach with their hands. Accordingly, it may be inconvenient or even impossible for a ground crew member needs to personally carry a heavy charging connector and connect the same to a charging socket located in an elevated position on the vehicle.

Because of the difficulty of adjusting its position once it has landed on the ground, the eVTOL aircraft, the eVTOL aircraft may need to get as close as possible to the charger, and the ground crew may need to pull up the charging cable as closely as possible to the aircraft body. Because of the high voltage of the charging current required to charge a large amount of batteries in a short charging time, thicker and heavier charging cables may be required as compared to those of land-based electric vehicles. These working conditions may cause undue physical burden and pain on the ground crew and even become a source of musculoskeletal disorders in the crew members.

The matters described in this Background section are only for enhancement of understanding of the background of the disclosure, and should not be taken as acknowledgement that they correspond to prior art already known to those skilled in the art.

### SUMMARY

An aspect of the present disclosure is to provide a movable apparatus and a method for charging a mobility apparatus, that may automatically provide charge, regardless of a position and an installation height of a charging socket in the mobility apparatus, thereby reducing labor of a worker.

According to one or more example embodiments of the present disclosure, a charging apparatus may include a mobile robot capable of autonomous driving. A charging cable may be connected to one side of the mobile robot. The charging apparatus may further include a robot arm installed on the mobile robot. The robot arm may include an end effector. The charging apparatus may further include a charging connector mounted on the end effector and electrically connected to the charging cable.

The mobile robot may include: a plurality of wheels; one or more motors configured to drive the plurality of wheels independently of each other; and a power supply configured to supply power to the one or more motors.

The mobile robot may further include: one or more sensors configured to detect one or more objects in a surrounding environment of the charging apparatus. The one or more sensors may include at least one of an image sensor or a lidar. The mobile robot may further include a controller electrically connected to the one or more sensors. The controller may be configured to control, based on data received from the one or more sensors, a driving operation of the plurality of wheels.

The robot arm may further include: a base; a plurality of links; and a coated conductor electrically connected to the charging cable. The coated conductor may run along the base, the plurality of links, and the end effector to connect to the charging connector. The robot arm may be capable of multi-joint movement.

The charging apparatus may further include: a controller electrically connected to the robot arm. The controller may be configured to control movement and position of the charging connector by controlling a motor in the robot arm.

The charging connector may be connectable to a charging socket of a mobility apparatus. The charging connector may include a positioning sensor for detecting a position of the charging socket. The positioning sensor may be mounted on the charging connector and electrically connected to the controller. The controller may be further configured to control the motor in the robot arm based on data received from the positioning sensor.

The positioning sensor may be configured to acquire image data associated with the charging socket. The controller may be configured to: detect, in the acquired image based on a deep learning model, the charging socket; and output coordinates associated with the position of the charging socket.

The charging apparatus may further include a cooling circuit disposed in the mobile robot and the robot arm and configured to dissipate heat generated by the coated conductor.

The cooling circuit may include: a refrigerant tank configured to store a refrigerant; a pump configured to pressurize and circulate the refrigerant from the refrigerant tank; a radiator configured to cool the refrigerant after a temperature of the refrigerant is raised; and a refrigerant hose connecting the refrigerant tank, the pump, and the radiator for circulation of the refrigerant. The refrigerant hose may be disposed, in the robot arm, to run along the coated conductor.

The radiator may include a cooling fan. The cooling circuit may further include a heater configured to control the temperature of the refrigerant.

The charging connector may include a housing. An edge of the housing may be formed by chamfering to have a curved surface or an inclined surface.

The charging connector may be connectable to a charging socket of a mobility apparatus. The charging apparatus may further include a gimbal interposed between the end effector and the charging connector to mitigate a spatial displacement between the charging connector and the charging socket.

The gimbal may include: a ball joint having a ball stud. An end portion of the ball stud may be fixedly connected to the end effector. The gimbal may further include a plurality of springs disposed, between the end effector and the charging connector, at regular intervals from each other around the ball joint; and a plurality of displacement sensors. Each of the plurality of displacement sensors may be disposed in a corresponding spring of the plurality of springs and installed on the end effector to form a cantilever.

The mobile robot may include a controller electrically connected to the robot arm. The plurality of displacement sensors may be electrically connected to the controller. The controller may be configured to control, based on data received from the plurality of displacement sensors, movement of the robot arm.

The controller may be configured to control the movement of the robot arm by: determining, based on measurements by the plurality of displacement sensors, a plurality of distances between the charging connector and the end effector; determining, based on a deviation among the plurality of distances between the charging connector and the end effector, an insertion angle of the charging connector and an angle adjustment amount; and controlling, based on the determined angle adjustment amount, the movement of the robot arm to adjust a position of the end effector. Each of the plurality of distances may be measured by a corresponding displacement sensor of the plurality of displacement sensors.

The charging apparatus may further include an elevating platform installed on the mobile robot and configured to elevate or lower the robot arm relative to the mobile robot. The elevating platform may include: a first platform on which the robot arm is mounted; a second platform disposed on the mobile robot; a plurality of scissor linkages disposed between the first platform and the second platform to connect the first platform to the second platform; and a first motor mounted on the second platform and configured to move the plurality of scissor linkages.

The elevating platform may further include a pair of link assemblies disposed at a predetermined distance from each other. Each of the pair of link assemblies may include the plurality of scissor linkages. The pair of link assemblies may be connected by a plurality of shafts that connect to hinges of the plurality of scissor linkages.

The charging apparatus may further include: a bearing block installed on one side of the second platform; a nut provided on one of the plurality of shafts; and a bolt shaft rotatably installed between the bearing block and the nut. The first motor may be connected to the bolt shaft and configured to rotate the bolt shaft in a forward or reverse direction.

The second platform may be mounted on at least one rail disposed on the mobile robot such that the second platform is slidable along the at least one rail. The mobile robot may include a second motor configured to cause the second platform to slide across the mobile robot.

According to one or more example embodiments of the present disclosure, a charging apparatus may include a mobile robot capable of autonomous driving. A charging cable may be connected to one side of the mobile robot. The charging apparatus may further include a robot arm installed on the mobile robot; an elevating platform installed on the mobile robot and configured to elevate or lower the robot arm relative to the mobile robot; and a charging connector mounted on an end of the robot arm and electrically connected to the charging cable. An orientation of the charging connector may be configured to be adjustable relative to the end of the robot arm.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view illustrating a charging apparatus and an enlarged view of an end effector and a charging connector.

FIG. 2 is a view illustrating a control relationship of a charging apparatus.

FIG. 3 is a perspective view illustrating a connection between an end effector and a charging connector.

FIG. 4 is a view illustrating a process of inserting a charging connector into a charging socket of a mobility apparatus.

FIG. 5 is a view illustrating a cooling circuit of a charging apparatus.

FIG. 6 is a perspective view illustrating a charging apparatus.

FIG. 7 is a view illustrating an application example of a charging apparatus according to the present disclosure.

FIG. 8 is a flow chart illustrating a charging method according to the present disclosure.

FIG. 9 shows an example computing system.

### DETAILED DESCRIPTION

Hereinafter, the present disclosure will be described in detail through example drawings. When adding reference numerals to components in each drawing, it should be noted that the same components are given the same numerals as much as possible even if they are illustrated in different drawings.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming. The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., detecting positions of a mobile robot and a mobility apparatus to be charged) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., detecting positions of a mobile robot and a mobility apparatus to be charged) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., detecting positions of a mobile robot and a mobility apparatus to be charged) described herein.

Minimum risk maneuver (MRM) operation(s) may also be controlled, for example, based on one or more features (e.g., detecting positions of a mobile robot and a mobility apparatus to be charged) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., detecting positions of a mobile robot and a mobility apparatus to be charged) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., detecting positions of a mobile robot and a mobility apparatus to be charged) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., detecting positions of a mobile robot and a mobility apparatus to be charged) described herein.

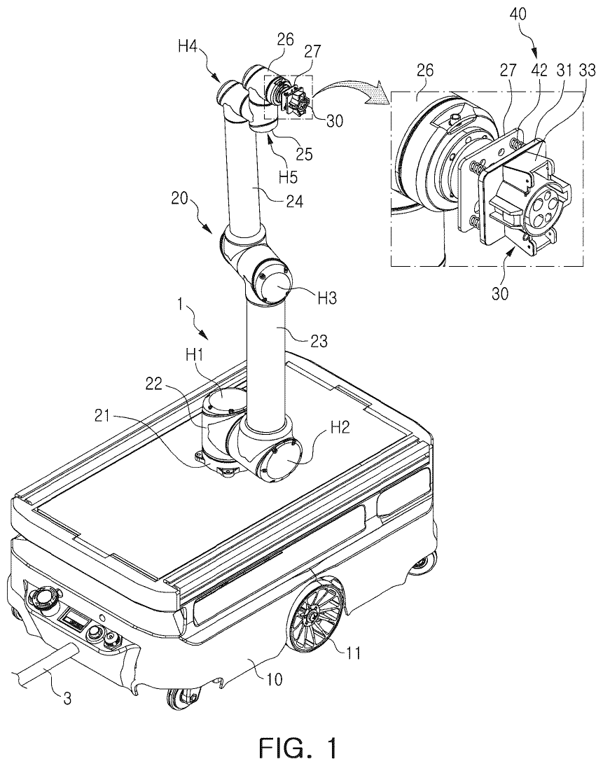

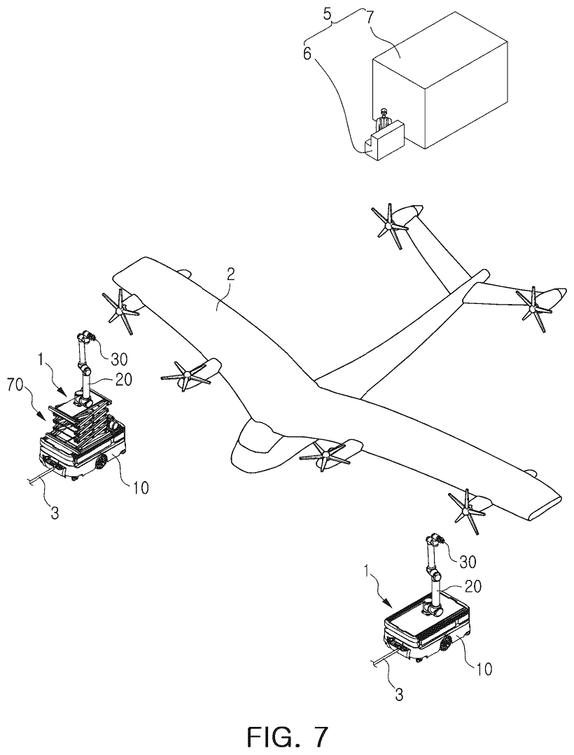

The various principles disclosed herein regarding the autonomous driving operations of a vehicle may be applied to an unmanned vehicle, such as an apparatus 1 as shown in FIGS. 1-7 and/or an apparatus 2 as shown in FIG. 7. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), etc.).

In the present specification, for the convenience of explanation, the present disclosure is described by exemplifying a case in which the present disclosure is applied to an air mobility apparatus such as an electric vertical takeoff and landing (eVTOL) aircraft, but the present disclosure is not limited thereto. For example, it may be applied not only to an air mobility apparatus but also to a land-based mobility apparatus (e.g., a vehicle), a water or underwater mobility apparatus, a space-based mobility apparatus, etc.

In addition, the terms first, second, third, fourth, fifth, etc. may be used to describe various components, but these components are not limited in terms of an order, a size, a position, or importance by the terms first to fifth, etc., and may be named only for the purpose of distinguishing one component from another.

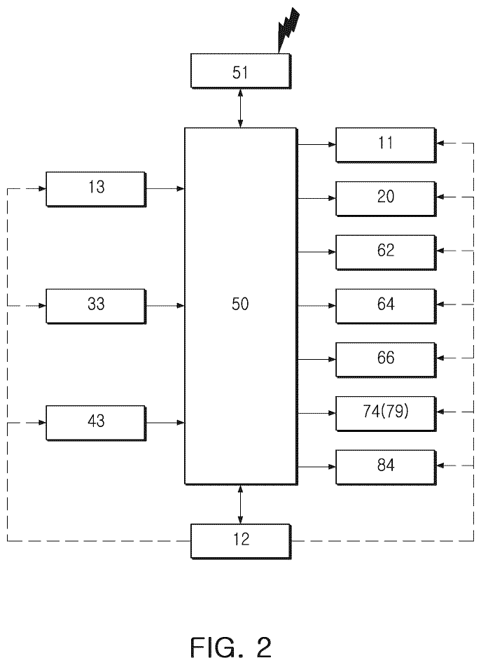

FIG. 1 is a perspective view illustrating a charging apparatus, and an enlarged view of an end effector and a charging connector, and FIG. 2 is a view illustrating a control relationship of a charging apparatus.

As illustrated in FIGS. 1 and 2, a charging apparatus 1 may include a mobile robot 10, a robot arm 20, and a charging connector 30.

The mobile robot 10 may be an autonomous moving platform. The mobile robot 10 may move the charging connector 30 to a target location (e.g., a location of a mobility apparatus 2 to be charged, as shown in FIG. 7). A charging cable 3 may be connected to one side of the mobile robot 10, and the charging connector 30 may be electrically connected to the charging cable 3 in the mobile robot 10 or the robot arm 20. The mobile robot may tow the charging cable 3.

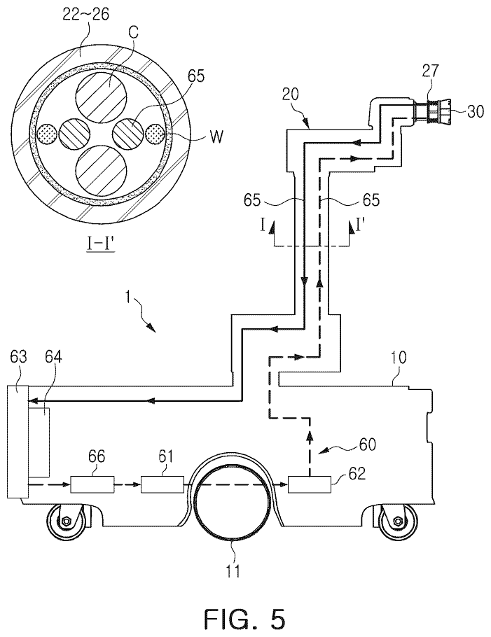

For electrical connection between the charging cable 3 and the charging connector 30, for example, a coated (e.g., jacketed, insulated, etc.) conductor C (see FIG. 5) may be provided in the mobile robot 10 and/or the robot arm 20. However, the electrical connection may not be necessarily limited to the above-described example, and the electrical connection may be made by passing the charging cable 3 through the mobile robot and robot arm, and physically connecting the charging cable 3 directly to the charging connector 30, without a separate conductor.

The mobile robot 10 may include a plurality of frames and a plurality of plates to form a receiving space (e.g., storage space) therein. In addition, the mobile robot may include one or more wheels 11 disposed on a lower surface at both sides (e.g., on left and right). At least two pairs of wheels 11 may be mounted on the mobile robot for stable support, but the number of wheels is not necessarily limited thereto.

Autonomous driving (e.g., with or without a human operator) may be possible in the mobile robot 10, and a driving direction, a driving speed, a turning direction, a turning speed, a stop position, obstacle avoidance, emergency stop, or the like may be controlled by a controller (also referred to as a control unit) 50, described below.

For driving and control of such autonomous driving operations, the mobile robot 10 may include a power supply 12 that supplies power to other components. The power supply may include, for example, a battery that may be charged and discharged, but may not be necessarily limited thereto, and may further include, for example, a power converter receiving and converting commercial power (e.g., grid power), a voltage stabilizer outputting a stable voltage, or the like.

Each of the plurality of wheels 11 may be driven by one or more motors (e.g., actuators, servos, etc.). For example, steering may be achieved by driving the plurality of wheels independently of each other, and power for forward rotation may be applied to motors of wheels on only one side (e.g., right or left), while no power is applied or power for reverse rotation is applied to motors of wheels on the other (e.g., opposite) side. Power may be applied to the motors from the power supply 12.

Optionally, each of the wheels 11 may be equipped with an in-wheel motor, and may be driven by the individual in-wheel motor. As the in-wheel motor is driven in forward or reverse rotation, the wheel may rotate forward or backward, and the mobile robot 10 may move in a forward direction or a backward direction. In addition, since a plurality of in-wheel motors are driven independently of each other, the wheels on each side may rotate in different speeds and/or directions, or the wheels on one side may be stopped, to perform steering.

In this manner, by driving the plurality of wheels 11 independently of each other, the mobile robot 10 may move by performing forward movement or backward movement in a forward direction or a backward direction, as well as by freely changing a direction (e.g., having a small or zero turn radius) in a left direction or a right direction.

In addition, for driving and controlling autonomous driving operations, the mobile robot 10 may include one or more sensors (also referred to as driving sensors) 13 that detect a position or location of the mobility apparatus 2 (as shown in FIG. 7) and other objects in a surrounding environment. The sensors 13 may include, for example, an image sensor (e.g., a camera, etc.) and/or a lidar.

The one or more sensors 13 may be electrically connected to the controller 50, and the controller may control driving of the wheels 11, based on data detected by the one or more sensors.

For example, an autonomous driving technique based on recognition of a quick response (QR) code of a camera may be used. Position information of the mobile robot 10 may be recognized by taking (e.g., photographing) images of QR codes disposed on the ground (or on other surfaces such as walls, ceilings, signages, etc.) at predetermined intervals with the camera, enlarging the acquired image of the QR code using an interpolation method, binarizing (e.g., digitizing) the same, and detecting and interpreting the same in a library.

Alternatively, a simultaneous localization and mapping (SLAM) algorithm may be utilized to estimate a position by extracting and matching feature points from an image sequence obtained through the lidar sensor and/or the camera.

The controller 50 may use other various technologies to control robots or vehicles for autonomous driving control.

The robot arm 20 may be mounted on the mobile robot 10. The robot arm 20 may be capable of multi-joint driving (e.g., multi-joint movement or operation). For example, a multi-joint robot arm having at least six axes may be employed as the robot arm 20. In this case, the robot arm 20 may include a base (also referred to as an arm base or an arm attachment) 21, a first link 22, a second link 23, a third link 24, a fourth link 25, a fifth link 26, and an end effector (also referred to as a robot end effector, an end-of-arm tooling, a tool receptacle, etc.) 27. The robot arm 20 may have more links or fewer links than it is shown in FIG. 1. Although FIG. 1 shows the mobile robot 10 as having only one robot arm 20 mounted on it, the mobile robot 10 may have more than one robot arms 20 mounted on it to perform various tasks. One or more portions (e.g., links) of the robot arm 20 may rotate around one or more axes (e.g., hinge axes, rotational axes, etc.), such as a hinge axis H1, a hinge axis H2, a hinge axis H3, a hinge axis H4, a hinge axis H5, and so forth (collectively, hinge axes H).

The base 21 may be fixedly (e.g., permanently, semi-permanently, etc.) installed on the mobile robot 10, and a component such as a motor (e.g., an actuator, a servo, etc.), a speed reducer, or the like may be accommodated in the base.

The first link 22 may rotate about (e.g., with respect to) the base 21 having a vertical axis of rotation, such as the hinge axis H1. The rotation of the first link may be performed by a motor (e.g., an actuator, a servo, etc.), a speed reducer, or the like in the base.

The second link 23 may rotate relative to the first link 22 via the hinge axis H2. The hinge axis H2 may be connected to a motor (e.g., an actuator, a servo, etc.).

The third link 24 may be bent (e.g., rotated) relative to the second link 23 via the hinge axis H3. The hinge axis H3 may be connected to a motor (e.g., an actuator, a servo, etc.).

The fourth link 25 may rotate relative to the third link 24 via the hinge axis H4. The hinge axis H4 may be connected to a motor (e.g., an actuator, a servo, etc.).

The fifth link 26 may rotate relative to the fourth link 25 via the hinge axis H5 while the end effector 27 may be installed. The hinge axis H5 may be connected to a motor (e.g., an actuator, a servo, etc.).

In addition, the end effector 27 may rotate relative to the fifth link around a direction, perpendicular to the hinge axis H5 between the fourth link 25 and the fifth link 26.

Each of the hinge axes H may be connected to a motor (e.g., an actuator, a servo, etc.), or the motor and a speed reducer, and the motors may be electrically connected to the controller 50 described below, and may be driven (e.g., operated, controlled, etc.) under control of the controller. In addition, for multi-joint driving of the robot arm 20, the motors of the robot arm may be electrically connected to the power supply 12, and power may be applied.

A wire W supplying power to each of the motors and controlling driving of the motors may be accommodated (e.g., disposed, installed, etc.) in the base 21 and the plurality of links 22 to 26 constituting the robot arm 20, together with the coated conductor C electrically and/or physically connected to the charging cable 3. At least, the coated conductor may penetrate (e.g., run along) the end effector 27 to be connected to the charging connector 30.

The controller 50 may be electrically connected to a motor, such as an in-wheel motor, provided for each of the wheels 11 of the mobile robot 10 and a motor rotating the links 22 to 26 of the robot arm 20, to control driving of these motors. Therefore, the controller may control the in-wheel motor to control driving and steering of the mobile robot, and may control the motor in the robot arm to control movement and a change in position of the charging connector 30.

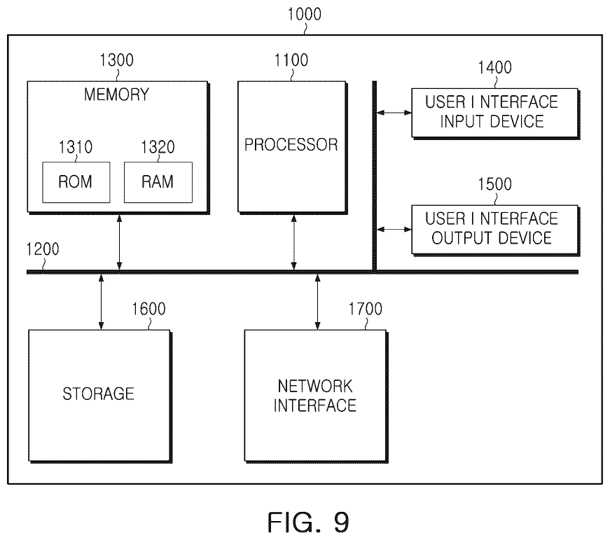

The controller 50 may be implemented with various processing devices, such as a computing device 1000 as shown in FIG. 9.

The controller 50 may include or be electrically connected a memory. The memory may store various programs and data for driving the mobile robot 10. The memory may share and store a pre-created map and a pre-created coordinate system with an upper control system 5.

The controller 50 may include or be electrically connected to a communication interface (also referred to as a communication unit) 51. Through the communication interface, the controller may communicate with the upper control system 5 and/or a battery management system (BMS) of the mobility apparatus 2.

The communication interface 51 may be capable of wireless communication, wired communication, or both. For example, the communication interface may receive a control signal wirelessly from the upper control system 5, and may transmit status information and position information of the mobile robot 10 to the upper control system.

The communication interface 51 may wirelessly communicate with the BMS of the mobility apparatus 2, for example, to receive information about status of the battery in the mobility apparatus, or monitor a temperature during charging in real time.

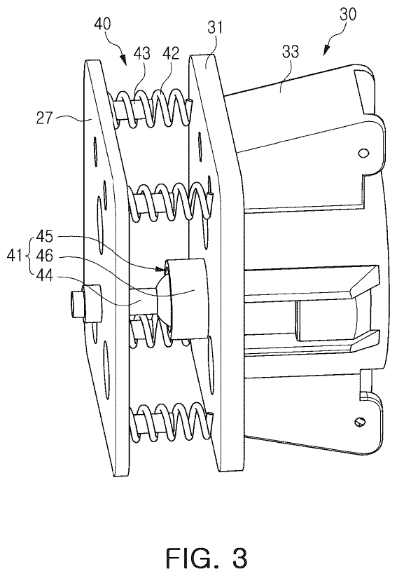

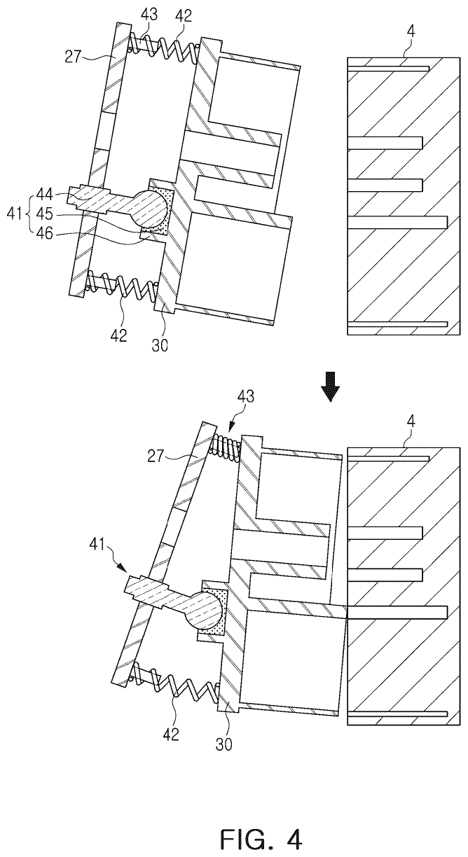

FIG. 3 is a perspective view illustrating a connection between an end effector 27 and a charging connector 30, and FIG. 4 is a view illustrating a process of inserting a charging connector 30 into a charging socket of a mobility apparatus.

A charging connector 30 may be mounted on an end effector 27 of a robot arm 20, and may be connected to a coated conductor C penetrating (e.g., running along) the end effector 27, to be electrically connected to a charging cable 3 through the coated conductor C. The charging connector 30 may be connected to a charging socket 4 of a mobility apparatus 2.

The charging connector 30 may include one or more connection terminals (not illustrated) installed in a housing 31 forming an exterior. These connection terminal(s) may be electrically connected to the coated conductor C and/or the charging cable 3, and when (e.g., while, after, etc.) the charging connector 30 is inserted into the charging socket 4, the connection terminals may be connected to terminals of the charging socket.

In the housing 31, an edge to be inserted into the charging socket 4 may be formed by, for example, chamfering, to have a curved surface or an inclined surface, such that the charging connector 30 may be smoothly (e.g., snugly) inserted and coupled to the charging socket 4.

Therefore, a charging apparatus 1 may electrically connect the charging cable 3 to a battery in the mobility apparatus 2 through connection of the charging connector 30 and the charging socket 4, thereby providing power supplied and converted from an electrical grid to the battery and charging the battery.

The charging connector 30 may be equipped with a target sensor (also referred to as a positioning sensor) 33 detecting a position of the charging socket 4. The target sensor may be an image sensor, such as a camera or the like, but is not necessarily limited thereto.

The target sensor 33 may be electrically connected to a controller 50, and the controller may control driving of the robot arm 20 based on data detected by the target sensor.

A process of finding the position of the charging socket 4 in the mobility apparatus 2 using the target sensor 33 may include preprocessing and real-time processing. The preprocessing may include learning based on image data, and the real-time processing may include detecting position coordinates based on learned contents (e.g., machine learning model), and matching and inserting the charging connector 30 into the charging socket 4.

The preprocessing may start with acquiring and collecting a large amount of image data from the target sensor 33 at various angles, lighting, backgrounds, or the like. Collected data may be normalized by adjusting a magnitude of the image data, changing a color, or changing an angle after going through data labeling in the form of a bounding box in the controller 50.

The controller 50 may put preprocessed data into a deep learning engine, to perform detection and recognition of the charging socket 4.

Specifically, the controller 50 may recognize the charging socket 4 included in a surrounding environment, in an image, for example, by using a convolutional neural network (CNN) technique. The CNN technique may be designed such that layers are configured to extract characteristics of an image from an existing neural network, to classify even a new image.

The learning model is not necessarily limited to a model learned by the CNN technique, and it is obvious that a model learned by another type of deep learning technique may be used.

When a real-time image of the charging socket 4 and a surrounding thereof is input through the target sensor 33, the controller 50 may apply an image corresponding thereto to the learning model, to recognize the charging socket in the image, and may then output coordinates of the charging socket in a form of a bounding box, for example.

Therefore, the controller 50 may check the position of the charging socket based on extracted coordinates of the charging socket 4, and may control the robot arm 20 to move the charging connector 30 to the position of the charging socket. Then, if the charging connector 30 matches the position of the charging socket, the charging connector 30 may be inserted and connected to the charging socket by an operation of the robot arm.

Optionally, a compensation mechanism 40 may be interposed between the end effector 27 and the charging connector 30 such that a positional error (also referred to as a positional discrepancy, a spatial discrepancy, a positional displacement, a spatial displacement, etc.) between the charging connector 30 and the charging socket 4 may be absorbed (e.g., mitigated, reconciled, compensated, corrected, etc.). Such a compensation mechanism may include a ball joint 41, a plurality of springs 42, and a plurality of displacement sensors 43. The compensation mechanism 40 may be, for example, a gimbal, a gimbal head, a ball head, a tilt head, a pan and tilt head, a fluid head, etc.

The ball joint 41 may include a ball stud 44 having a rod integrally formed on a head having a spherical shape; a bearing 45 formed in a substantially cylindrical shape and at least partially surrounding the head; and a case 46 formed to have a cylindrical shape opened toward one side and at least partially surrounding an exterior of the bearing.

An end portion of the rod in the ball stud 44 may be fixedly connected to the end effector 27, and a closed surface of the case 46 may be fixedly connected to a back surface of the charging connector 30, that is, to a surface, opposite to a front surface in which the connection terminal of the charging connector 30 is exposed.

The plurality of springs 42 may be disposed at predetermined intervals from each other to surround the ball joint 41 between the end effector 27 and the charging connector 30. One end of each of the springs may be connected to the end effector 27, and the other end thereof may be connected to the charging connector 30.

One or more coil springs may be employed as the springs 42, and the drawings illustrate an example in which four coil springs are disposed around the ball joint 41. Shapes and the number of springs are not limited to examples described above and illustrated, and other shapes and/or numbers of springs may be used.

Each of the plurality of displacement sensors 43 may be disposed to be accommodated in the spring 42. Each of the displacement sensors 43 may be installed at or on the end effector 27. For example, each of the displacement sensors 43 may be fixedly installed to the end effector 27 in a cantilever position. For example, only one end of each of the displacement sensors 43 may be fixed to the end effector 27. Each of the displacement sensors 43 may be disposed on the end effector 27 to correspond to a corner of the charging connector 30 in the charging connector 30 having a polygonal shape.

The displacement sensor 43 may be, for example, a linear potentiometer or a linear variable differential transformer (LVDT), but the displacement sensor 43 is not necessarily limited thereto.

Each of the displacement sensors 43 may be electrically connected to the controller 50, and the controller may control driving of the robot arm 20, based on data detected by these displacement sensors 43.

In such a compensation mechanism 40, the ball joint 41 may enable the charging connector 30 to pivot relative to the end effector 27, such that the charging connector 30 has a sufficient degree of insertion freedom. In addition, the ball joint may maintain a constant (e.g., average) gap between the charging connector 30 and the end effector 27.

The plurality of springs 42 may absorb errors occurred (e.g., reconcile the difference) between the charging connector 30 and the charging socket associated with the charging connector 30 being inserted into the charging socket 4 due to an incorrect posture, an incorrect direction, and an incorrect angle of the charging connector 30 relative to the charging socket.

In this case, errors of the charging connector 30 may be sensed and measured by at least one of the displacement sensors 43 accommodated in each of the springs 42.

As illustrated in FIG. 4, in inserting the charging connector 30 into the charging socket, when one of the plurality of displacement sensors 43 is in contact with the charging connector 30 due to angular misalignment of the charging connector 30 with respect to the charging socket 4, displacement values of the corresponding displacement sensor 43 may be transmitted to the controller 50.

The controller 50 may calculate (e.g., determine), based on an input displacement value of the displacement sensor 43, a distance between the charging connector 30 and the end effector 27 in a position corresponding to the displacement sensor 43, from which the displacement value is input, and may calculate (e.g., determine) an insertion angle of the charging connector 30 and an angle compensation amount (also referred to as an angle compensation amount) from a deviation of this distance and a distance between the charging connector 30 and the end effector 27 in a position corresponding to a remaining displacement sensor 43.

The controller 50 may drive the robot arm 20 by the calculated angle compensation amount to correct (e.g., adjust) a position of the end effector 27 and a position of the charging connector 30, and may re-insert the charging connector 30 into the charging socket 4.

FIG. 5 is a view illustrating a cooling circuit of a charging apparatus.

The charging apparatus 1 may further include a cooling circuit 60 for cooling heat generated, during charging, in a coated conductor C (or a charging cable 3) through which high-voltage electricity flows.

The cooling circuit 60 may include a path for cooling the coated conductor C (or the charging cable 3). Specifically, the cooling circuit may be configured such that heat generated by the coated conductor during charging is absorbed by a refrigerant and the heat is forcibly released (e.g., dissipated) from a heated refrigerant.

The cooling circuit 60 may include a refrigerant tank 61, a pump 62, a radiator 63, and a refrigerant hose 65. The refrigerant tank 61, the pump 62, the radiator 63, or the like may be disposed on the mobile robot 10.

The refrigerant tank 61 may receive and store the refrigerant, and the pump 62 may be driven with power received from a battery of a power supply 12. The pump 62 may circulate the refrigerant by pressurizing the refrigerant from the refrigerant tank 61. In this case, the refrigerant may be water or an incompressible fluid.

The radiator 63 may be a type of heat exchanger for cooling the refrigerant flowing along the refrigerant hose 65, and may include a cooling fan 64 that rotates with power received from the battery of the power supply 12.

For example, a temperature sensor (not illustrated) may be installed in the radiator 63 or the refrigerant hose 65 upstream thereof to sense a temperature of the refrigerant, and a detected temperature may be transmitted to a controller 50. The pump 62 may be operated under control of the controller according to the temperature of the refrigerant. In addition, the cooling fan 64 may rotate under the control of the controller to send a constant amount of air to the radiator, but may not operate in a low-temperature environment.

The refrigerant hose 65 may be formed of a flexible material. The refrigerant hose 65 may connect between components of the cooling circuit 60, and cause the refrigerant therein to circulate. The refrigerant hose may extend to a charging connector 30 through the mobile robot 10, a base 21 of a robot arm 20, links 22 through 26, and an end effector 27.

For example, in the robot arm 20, the refrigerant hose 65 may be disposed to be adjacent to and parallel to (e.g., run along) the coated conductor C, which may be a heat source. Therefore, when heat is generated in the coated conductor during charging, the heat may be released from the coated conductor to the refrigerant hose, and the refrigerant may absorb the heat. The coated conductor that has released the heat may be cooled.

The refrigerant, which may absorb heat while cooling the coated conductor C and the charging connector 30, may be cooled by the radiator 63, may then flow into the refrigerant tank 61. The refrigerant may be circulated toward the charging connector 30 by the pump 62. In FIG. 5, the heated refrigerant is indicated by a thick solid line, and the cooled refrigerant is indicated by a thick dotted line.

Therefore, heat generated during charging in the high-voltage coated conductor C (or the charging cable 3) may be effectively cooled, thereby improving a charging efficiency of a charging apparatus 1 (e.g., by keeping the charging apparatus 1 within a desired/optimal temperature range).

Optionally, the cooling circuit 60 may further include a heater 66 for controlling the temperature of the refrigerant. The heater 66 may be an electric heater, and may be heated with power received from the battery of the power supply 12. However, the heater 66 is not necessarily limited to the electric heater.

If the battery is being charged in a low temperature environment, an overvoltage increase of positive and negative conductors may increase asymmetrically. As a result, charging capacity may decrease, as compared to charging in a room temperature environment, and voltage of the negative conductor may drop very low.

To resolve this problem, in the low temperature environment (e.g., an environment with a temperature below a threshold temperature), the temperature of the refrigerant may appropriately increase by using the heater 66, thereby controlling a temperature of the coated conductor C and quickly charging the battery of the mobility apparatus 2.

The heater 66 may be disposed between the radiator 63 and the refrigerant tank 61 in the mobile robot 10, but is not necessarily limited thereto. The heater 66 may be disposed to partially surround the refrigerant hose 65, or may be configured such that the refrigerant is introduced into the heater 66, and is then discharged.

For example, a temperature sensor (not illustrated) may be installed in the radiator 63 or the refrigerant hose 65 downstream thereof to detect a temperature of the refrigerant, and a detected temperature may be transmitted to the controller 50. The heater 66 may be heated under control of the controller according to the temperature of the refrigerant.

Therefore, even if the refrigerant is excessively cooled by the radiator 63 in a low temperature environment, an advantage of being able to control the temperature of the refrigerant by the heater 66 to support an optimal charging speed may be obtained.

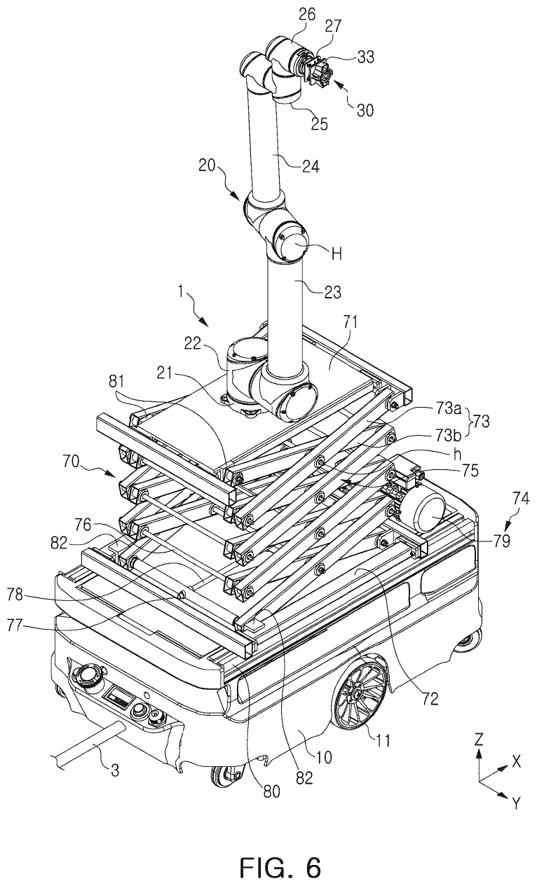

FIG. 6 is a perspective view illustrating a charging apparatus.

As illustrated in FIG. 6, a charging apparatus 1 may include a mobile robot 10; a robot arm 20; and a charging connector 30.

The charging apparatus 1 as shown in FIG. 6 may include an elevating unit 70, and other components may be similar or identical to the corresponding components shown in other drawings. Therefore, in explaining the charging apparatus 1 of FIG. 6, descriptions of other components will be omitted.

As shown in FIG. 6, the charging apparatus 1 may further include an elevating unit (also referred to as an elevator, a lift, an aerial lift, an elevating platform, etc.) 70 that is capable of raising the robot arm 20 from the mobile robot 10 or lowering the robot arm toward the mobile robot. For example, the elevating unit 70 may be a scissor lift, an aerial device, a knuckle boom lift, an articulated boom lift, a telescoping boom, a spider lift, etc., but it is not necessarily limited thereto.

The elevating unit 70 may include a first support portion (also referred to as a first platform) 71, a second support portion (also referred to as a second platform) 72, at least one X-link (also referred to as a scissor linkage) 73, and a first driving unit (e.g., actuator, motor, servo, etc.) 74.

The first support portion 71 may be a member having a substantially plate shape, and the robot arm 20 may be mounted on the first support portion.

The second support portion 72 may be a member having a substantially frame shape, and the first driving unit 74 driving the X-link 73 may be mounted on the second support portion. The second support portion may act as a connecting member connecting the elevating unit 70 and the mobile robot 10.

The at least one X-link 73 may be disposed between the first support portion 71 and the second support portion 72 to connect the first support portion and the second support portion. In a case in which the X-link is provided as a plurality of X-links, the X-links may be connected to each other in a height direction. Although four X-links are illustrated in FIG. 6, the number of X-links is not necessarily limited thereto.

The X-link 73 may include a pair of link members 73a and 73b intersecting in an X shape. A hinge h may be provided in both end portions and an intermediate portion of each of the link members. The hinge may be connected to the intermediate portion of the pair of link members, such that the link members may form the X-link, and the pair of link members may rotate relative to each other.

Due to this configuration, one end portion or both end portions of each of the link members 73a, 73b may move in a longitudinal direction X of the mobile robot 10, and each X-link 73 may be unfolded or folded in a height direction Z. Therefore, a height between the first support portion 71 and the second support portion 72 may be adjusted, and an effect of the elevating unit 70 lifting the robot arm 20 may be obtained.

One X-link 73 may form a link assembly 75. The link assembly 75 may be a deployable structure. Alternatively, a plurality of X-links 73 may be connected in the height direction to form a single link assembly 75 by connecting with another X-link 73 adjacent above or below through hinges h in both end portions of the pair of link members 73a and 73b.

The elevating unit 70 may include a pair of link assemblies 75 disposed spaced apart from each other in a width direction (e.g., Y-axis as shown in FIG. 6) of the mobile robot 10 and connected to each other.

The link assemblies 75 of the same shape facing each other may be connected while maintaining a gap by a plurality of connecting shafts 76 connecting the hinges h facing each other in the width direction Y of the mobile robot 10. These connecting shafts may be integrated with hinges of link members 73a and 73b connected in both end portions, and may act as hinge axes.

By connecting the pair of link assemblies 75 in this manner, the elevating unit 70 may be extended or contracted stably and quickly without shaking.

The link members 73a, 73b constituting one X-link 73 may have the same length as link members constituting another X-link, but are not necessarily limited thereto.

The first driving unit 74 may include: a bearing block (not illustrated) installed on one side frame of the second support portion 72; a nut portion 77 provided on a lowermost connecting shaft, among the connecting shafts 76 connecting the pair of link assemblies 75; a bolt shaft 78 rotatably installed between the bearing block and the nut portion; and a driving motor 79 connected to the bolt shaft to rotate the bolt shaft in a forward or reverse direction.

A motor shaft of the driving motor 79 may be directly connected to the bolt shaft 78 to transmit driving force. Alternatively, a transmission means such as a gear or the like may be disposed between the driving motor and the bolt shaft, such that the motor shaft of the driving motor is indirectly connected to the bolt shaft.

Driving force generated by the driving motor 79 may rotate the bolt shaft 78 directly or via the transmission means, and rotation of the bolt shaft causes the nut portion 77 to move along the bolt shaft. As a result, the link members 73a, 73b of the X-link 73 located in a lowermost position may be closed or opened in the longitudinal direction X of the mobile robot 10, such that the elevating unit 70 is extended or contracted and the robot arm 20 is entirely raised or lowered.

In addition, the elevating unit 70 may further include a first slider 81 sliding along a side edge of the first support portion 71, and a second slider 82 sliding along a side frame of the second support portion 72.

In this case, in one link assembly 75, an upper end of one link member 73a among the link members of the X-link 73 located on an uppermost end, may be rotatably connected while a position thereof is fixed to the first support portion 71, and an upper end of the other link member 73b may be rotatably connected to the first slider 81.

In addition, in the one link assembly 75, a lower end of the one link member 73a among the link members of the X-link 73 located on a lowermost end, may be rotatably connected to the second slider 82, and a lower end of the other link member 73b may be rotatably connected while a position thereof is fixed to one frame on which the bearing block is installed, in the second support portion 72.

As a result, the link members 73a, 73b of the X-link 73 may smoothly close or open in the longitudinal direction X of the mobile robot 10, such that the entire robot arm 20 may be smoothly raised or lowered.

Optionally, in the charging apparatus 1, at least one rail 80 may be disposed on an upper surface of the mobile robot 10, and the second support portion 72 of the elevating unit 70 may be slidably mounted on the rail (e.g., the elevating unit 70 may slide along or across the rail), such that the elevating unit may move in the longitudinal direction X of the mobile robot on the upper surface of the mobile robot.

To this end, a second driving unit (e.g., actuator, motor, servo, etc.) 84 (see FIG. 2) applying driving force to the second support portion 72 of the elevating unit 70 disposed on the rail 80, to move (e.g., slide) the elevating unit in the longitudinal direction X of the mobile robot, may be installed on the upper portion of the mobile robot 10.

As the second driving unit 84, for example, a solenoid actuator with an operating rod, a linear motion guide with a ball screw, or the like may be employed. The second driving unit is not necessarily limited to the above-described example, and a fluid pressure cylinder such as a pneumatic cylinder, or the like may be employed.

In this case, the driving motor 79 of the first driving unit 74 and the second driving unit 84 may be electrically connected to the controller 50, to be driven under control of the controller. In addition, the driving motor of the first driving unit and the second driving unit may be electrically connected to a power supply 12, to receive power.

The charging apparatus 1, configured as described above, may perform autonomous driving of the mobile robot 10, and may additionally move the robot arm 20 in the longitudinal direction and/or the height direction of the mobile robot by utilizing the elevating unit 70 (for example, a scissor lift) disposed on the rail 80 while the mobile robot is stopped.

By the elevating unit 70 and the robot arm 20, the charging connector 30 may sufficiently reach and be connected to the charging socket 4 of the mobility apparatus 2 located in a high position of about 2 to 3 meters from a ground, for example.

Therefore, the charging apparatus 1 may obtain an effect of enabling automatic charging regardless of a position and installation height of the charging socket 4 by further expanding a range accessible to the end effector 27 of the robot arm 20, compared to when the elevating unit 70 is not included.

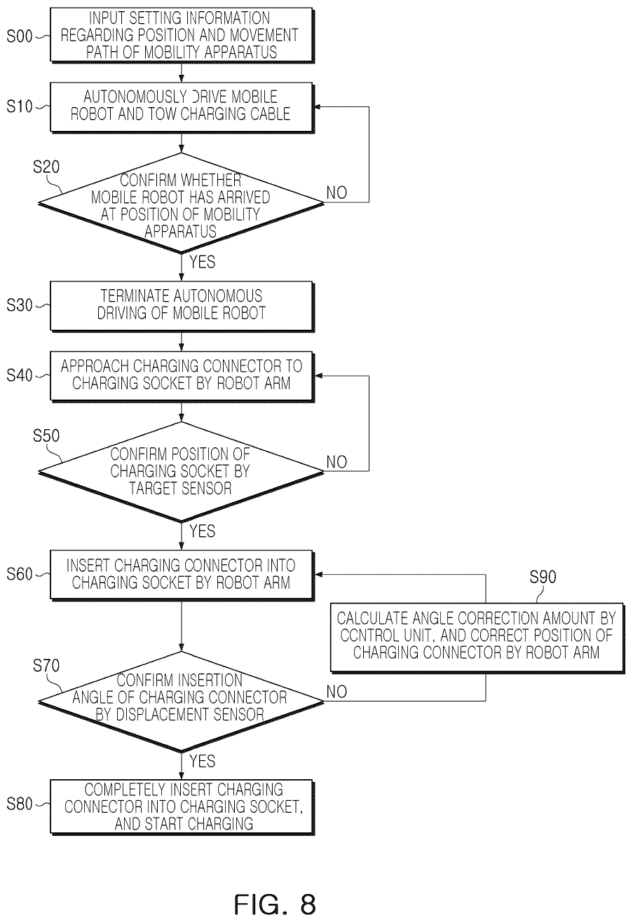

FIG. 7 is a view illustrating an application example of a charging apparatus according to the present disclosure, and FIG. 8 is a flow chart illustrating a charging method according to the present disclosure.

A charging apparatus 1 according to the present disclosure may be applied to a mobility apparatus 2 such as an eVTOL aircraft, for example. Such an eVTOL aircraft may be used for an individual or a plurality of passengers to move in a city or between cities. In addition, the eVTOL aircraft may also be used for delivery of a cargo, such as a courier service or the like.

The mobility apparatus 2 may include an aviation mobility apparatus that may fly and move (e.g., hover) in the sky.

In this case, the aviation mobility apparatus refers to not only a fixed-wing aircraft, a drone, a tilt-rotor aircraft, a vertical takeoff and landing aircraft, a rotary-wing aircraft, or the like, but also include all mobility apparatuses that may land and drive on a ground or a structure using a landing gear after flight.

In addition, the aviation mobility apparatus may include a manned aircraft and an unmanned aircraft. The manned aircraft may include aircraft that may be piloted by a pilot, as well as aircraft that may operate autonomously.

For the convenience of explanation, the charging apparatus 1 according to the present disclosure is described and illustrated as an example applied to an electric tilt rotor aircraft or an eVTOL aircraft that may take off and land in a narrow takeoff and landing area. Application examples of a charging apparatus according to the present disclosure are not necessarily limited thereto.

In the present specification, the mobility apparatus may mean various mobility apparatuses that move a transported object such as a person, an animal, an object, or the like, from a starting point to a destination. Such mobility apparatuses are not limited to the aviation mobility apparatuses, and may be interpreted to include a land-based electric vehicle that runs on a road or a track, an electric watercraft for water or underwater use, even a space-based aircraft, or the like.

A charging method using a charging apparatus 1 according to the present disclosure may include autonomously driving a mobile robot 10 toward a mobility apparatus 2 and towing a charging cable 3 (S10); confirming whether the mobile robot has arrived at a position of the mobility apparatus (S20); and terminating the autonomous driving of the mobile robot (S30).

First, when an eVTOL aircraft, which may be a mobility apparatus 2, has landed on a takeoff and landing area, a worker may input setting information regarding a position and a movement path of the mobility apparatus into a terminal 6 or a control device 7 of a ground control station (S00). In this case, the terminal and/or the control device may configure an upper control system 5.

The upper control system 5 may generate a movement path from a current position of a mobile robot 10 to the position of the mobility apparatus 2, and may control the mobile robot to move autonomously along the movement path.

Specifically, the upper control system 5 may transmit a control signal including at least one of a movement direction from the current position, a movement speed, destination coordinates, a driving path, and a position of a charging socket determined by type, to the mobile robot 10.

Through a communication interface 51, a controller 50 in the mobile robot 10 may receive a control signal for autonomous driving, and accordingly, the controller may control a power supply 12 and an in-wheel motor of a wheel 11, to control driving and steering of the mobile robot.

In addition, the mobile robot 10 may transmit status information including data acquired from a sensor 13, or the like, to the upper control system 5 in real time while moving along a set movement path.

Therefore, under control of the upper control system 5 and/or the controller 50, the mobile robot 10 may perform autonomous driving, may move toward the mobility apparatus 2, which has stopped, e.g., the eVTOL aircraft, and may tow a charging cable 3 connected to the mobile robot (S10).

In a case in which the mobility apparatus 2 is the eVTOL aircraft, the mobile robot 10 may enter under the eVTOL aircraft, and may approach a wing, a wing spar, a nacelle, or the like in which a charging socket 4 is located. In particular, the mobile robot may move and be located close to a target charging socket according to position information of the charging socket determined for each type of aircraft.

The controller 50 may independently confirm whether the mobile robot 10 has arrived at a position of the mobility apparatus 2, by using an autonomous driving technique based on recognition of a QR code of a camera, or an autonomous driving technique based on a SLAM algorithm extracting and matching feature points from an image sequence obtained through a lidar and/or a camera to estimate the position (S20).

The controller 50 may transmit position information of the mobile robot 10 to the upper control system 5, and when the mobile robot arrives at the position of the mobility apparatus 2, autonomous driving of the mobile robot may be terminated (S30).

In addition, a charging method using a charging apparatus 1 according to the present disclosure may include providing a charging connector 30 to a charging socket 4 of a mobility apparatus 2 by operating firstly a robot arm 20 (S40); confirming a position of the charging socket by a target sensor 33 (S50); when the charging connector 30 matches the position of the charging socket, inserting the charging connector 30 into the charging socket by operating secondarily the robot arm (S60); confirming an insertion angle of the charging connector 30 by a displacement sensor 43 (S70); and, when the insertion angle is within an allowable range, completely inserting the charging connector 30 into the charging socket, and starting charging (S80).

More specifically, when autonomous driving of a mobile robot 10 is terminated, a robot arm 20 may be firstly operated under control of a controller 50 to allow a charging connector 30 mounted on an end effector 27 to approach a charging socket 4 of a mobility apparatus 2, (e.g., an eVTOL aircraft) (S40).

Optionally, in a case in which an elevating unit 70 is provided on the mobile robot 10, the controller 50 may drive a first driving unit 74 to extend or contract the elevating unit, thereby raising or lowering the robot arm 20. As a result, a height of the end effector 27 of the robot arm may be adjusted.

Furthermore, in a case in which a rail 80 is provided on the mobile robot 10, the controller 50 may drive a second driving unit (e.g., actuator, motor, servo, etc.) 84 to move the robot arm 20 forward or backward in the longitudinal direction (e.g., X-axis as shown in FIG. 6) of the mobile robot 10. As a result, a movement distance of the end effector 27 of the robot arm may extend.

As links 22 to 26 of the robot arm 20 appropriately rotate, the end effector 27 may move according to a shape of the wing, a shape of the wing spar, a shape of the nacelle, or the like of the eVTOL aircraft, and in this case, a target sensor 33 may obtain image data in real time.

When the target sensor 33 captures the charging socket 4 and a surrounding thereof and inputs a real-time image to the controller 50, the controller may apply the image to a learning model using, for example, a CNN technique. When the charging socket is recognized in any image, the controller may output coordinates of the charging socket in a form of, for example, a bounding box and confirm a position of the charging socket (S50).

Based on the output coordinates of the charging socket 4, the robot arm 20 may be secondly operated to insert the charging connector 30 into the charging socket while matching the position of the charging socket 4 (S60).

Here, the coordinates of the charging socket 4 may have an error with an actual position of the charging socket due to physical factors or arbitrary factors.

In this case, when the charging connector 30 is inserted into the charging socket 4, a positional error between the charging connector 30 and the charging socket 4 may be sensed and measured by at least one of displacement sensors 43 accommodated in each spring 42 of a compensation mechanism 40. A displacement value of the displacement sensor 43 may be transmitted to the controller 50.

Based on an input displacement value of the displacement sensor 43, the controller 50 may calculate a distance between the charging connector 30 and the end effector 27 in a position corresponding to the displacement sensor 43, from which the displacement value is input, and may calculate an insertion angle of the charging connector 30 and an angle compensation amount from a deviation of this distance and a distance between the charging connector 30 and the end effector 27 in a position corresponding to a remaining displacement sensor 43.

In this manner, the controller 50 may confirm the insertion angle of the charging connector 30 into the charging socket, by the displacement sensor 43 (S70).

When a calculated insertion angle is within an allowable range, the robot arm 20 may be operated, as it is, such that the charging connector 30 may be completely inserted into the charging socket 4. When (e.g., while and/or after) the charging connector 30 is completely inserted into the charging socket, connection terminals of the charging connector 30 may be connected to terminals of the charging socket, and charging may begin (S80).

If the calculated (e.g., determined) insertion angle is outside of the allowable range, the controller 50 may thirdly operate the robot arm 20 by the calculated angle compensation amount, to correct positions of the end effector 27 and the charging connector 30, and then allow the charging connector 30 to be completely inserted into the charging socket 4 (S90).

When (e.g., while and/or after) the charging connector 30 is completely inserted into the charging socket 4, the connection terminals of the charging connector 30 may be connected to the terminals of the charging socket, and charging may begin.

Therefore, in the charging method according to the present disclosure, the charging cable 3 may be electrically connected to a battery in the mobility apparatus 2 through automatic connection of the charging connector 30 and the charging socket 4, such that power supplied and converted from a power grid may be provided to the battery, and the battery may be charged.

FIG. 9 shows an example computing system (e.g., a computing device of a vehicle or any other apparatus). One or more controllers, processors, etc. described herein may be implemented by the computing system or may be implemented in the computing system. One or more example embodiments described herein may be implemented by a hardware component, a software component, and/or a combination of the hardware component and the software component, such as one or more components shown in FIG. 9.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

For example, the computing system 100 may be a general-purpose computer or a special-purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions.

The processor 1100 may execute an operating system (OS) and one or more software applications executed in the operating system. In addition, the processor 1100 may access, store, manipulate, process, and generate data in response to execution of a software.

The processor 1100 may be used alone, but the processor 1100 may include a plurality of processing elements and/or various types of processing elements.

For example, the processor 1100 may include a plurality of processors, or a processor and a controller. Other processing configurations, such as parallel processors, are also possible.

The software may include computer programs, codes, instructions, or a combination of one or more of these, and may configure the processor 1100 to operate as desired or may independently or collectively command the processing device.

The software and/or the data may be permanently or temporarily embodied in any type of machine, component, physical device, virtual device, computer storage medium or device, such as the storage 1600, or transmitted signal waves for interpretation by the processor 1100 or for providing instructions or data to the processor 1100.

The software may be distributed over networked computer systems, and may be stored or executed in a distributed manner. The software and the data may be stored on one or more computer-readable recording media.

A method according to the present disclosure may be implemented in a form of program instructions that may be executed by various computer means, such as the processor 1100, and may be recorded on a computer-readable medium, such as the storage 1600. The computer-readable medium may include a program instruction, a data file, a data structure, or the like, alone or in combination. The program instruction recorded on such media may be those specially designed and configured or may be those known and available to those skilled in the art of computer software.

Examples of the computer-readable recording medium may include a magnetic medium such as a hard disk, a floppy disk, and a magnetic tape; an optical recording medium such as a CD-ROM and a digital video disc (DVD); a magneto-optical medium such as a floptical disk; and a hardware device configured to store and execute program instructions such as ROM, RAM, a flash memory, or the like

Examples of the program instructions may include not only a machine language code such as those generated by a compiler, but also a high-level language code that may be executed by a computer using an interpreter or the like. The hardware device may be configured to operate as one or more software modules to perform one or more operations as disclosed herein, and vice versa.

According to an aspect of the present disclosure, a charging apparatus includes a mobile robot capable of autonomous driving, and having a charging cable connected to one side of the mobile robot to tow the charging cable; a robot arm installed on the mobile robot and having an end effector; and a charging connector mounted on the end effector and electrically connected to the charging cable.

The mobile robot may include a wheel disposed in plural, a motor driving the wheel, and a power supplier, and the plurality of wheels are driven independently of each other.

The mobile robot may include a driving sensor having at least one of an image sensor or a lidar sensor, detecting a surrounding environment, and a control unit electrically connected to the driving sensor, and the control unit may control driving of the wheel, based on data detected by the driving sensor.

The robot arm may include a base, a plurality of links, and the end effector, and is capable of multi-joint driving, and the robot arm may include a coated conductor electrically connected to the charging cable, penetrating the base, the plurality of links, and the end effector, and connected to the charging connector.

The mobile robot may include a control unit electrically connected to the robot arm, and the control unit may control movement and a change in position of the charging connector by controlling a motor in the robot arm.

The charging connector may be connectable to a charging socket of a mobility apparatus, the charging connector may include a target sensor mounted to detect a position of the charging socket and electrically connected to the control unit, and the control unit may control driving of the robot arm based on data detected by the target sensor.

The target sensor may be capable of acquiring image data, and the control unit may recognize the charging socket in an acquired image using a model learned by a deep learning technique, and may then output coordinates of the charging socket.

The charging apparatus may further include a cooling circuit disposed in the mobile robot and the robot arm to cool heat generated by the coated conductor.

The cooling circuit may include a refrigerant tank receiving and storing a refrigerant; a pump pressing and circulating the refrigerant from the refrigerant tank; a radiator cooling the refrigerant of which temperature is raised; and a refrigerant hose connecting the refrigerant tank, the pump, and the radiator, and through which the refrigerant flows, wherein the refrigerant hose may be disposed in parallel with the coated conductor in the robot arm.

The radiator may include a cooling fan, and the cooling circuit may further include a heater controlling the temperature of the refrigerant.

The charging connector may include a housing forming an external shape, and an edge of the housing may be formed by chamfering to have a curved surface or an inclined surface.

The charging connector may be connectable to a charging socket of a mobility apparatus, and the charging apparatus may further include a compensation mechanism interposed between the end effector and the charging connector to absorb a positional error between the charging connector and the charging socket.

The compensation mechanism may include a ball joint having a ball stud, and in which an end portion of the ball stud is fixedly connected to the end effector; a plurality of springs disposed at intervals from each other to surround the ball joint between the end effector and the charging connector; and a plurality of displacement sensors respectively disposed to be received in the springs, and installed on the end effector in a cantilever shape.

The mobile robot may include a control unit electrically connected to the robot arm, the displacement sensor may be electrically connected to the control unit, and the control unit may control driving of the robot arm based on data detected by the displacement sensor.

The control unit may calculate a distance between the charging connector and the end effector in a position corresponding to the displacement sensor, from which a displacement value is input; may calculate an insertion angle of the charging connector and an angle compensation amount from a deviation of the calculated distance and a distance between the charging connector and the end effector in a position corresponding to a remaining displacement sensor; and may drive the robot arm by the calculated angle compensation amount to correct a position of the end effector.

The charging apparatus may further include an elevating unit installed on the mobile robot to elevate the robot arm from the mobile robot or to lower the robot arm toward the mobile robot.

The elevating unit may include a first support portion on which the robot arm is mounted; a second support portion disposed on the mobile robot; at least one X-link disposed between the first support portion and the second support portion to connect the first support portion and the second support portion; and a first driving unit mounted on the second support portion to drive the X-link.

The at least one X-link may form a link assembly, and the elevating unit may include a pair of the link assemblies disposed to be spaced apart from each other and connected by a plurality of connecting shafts connecting between hinges of the X-link facing each other.

The first driving unit may include a bearing block installed on one side of the second support portion; a nut portion provided on one of the connecting shafts; a bolt shaft rotatably installed between the bearing block and the nut portion; and a driving motor connected to the bolt shaft and rotating the bolt shaft in a forward or reverse direction.

At least one rail may be disposed on the mobile robot, the second support portion may be slidably mounted on the rail, and the mobile robot may include a second driving unit applying driving force to the second support portion.

According to the present disclosure, automatic charging may be possible regardless of a position and an installation height of a charging socket in a mobility apparatus, thereby reducing labor of a worker and preventing musculoskeletal disorders of the worker.

In addition, according to the present disclosure, a cooling circuit in which a refrigerant circulates may be provided in a charging apparatus to indirectly cool a charging connector and a conductor, thereby having an effect of improving a charging efficiency.

While one or more example embodiments have been illustrated and described above, it will be apparent to those skilled in the art that modifications and variations could be made without departing from the scope of the present disclosure as defined by the appended claims.

What is claimed is:

1. A charging apparatus comprising:
a mobile robot capable of autonomous driving, wherein a charging cable is connected to one side of the mobile robot;
a robot arm installed on the mobile robot, wherein the robot arm comprises an end effector; and
a charging connector mounted on the end effector and electrically connected to the charging cable.

2. The charging apparatus of claim 1, wherein the mobile robot comprises:
a plurality of wheels;
one or more motors configured to drive the plurality of wheels independently of each other; and
a power supply configured to supply power to the one or more motors.

3. The charging apparatus of claim 2, wherein the mobile robot further comprises:
one or more sensors configured to detect one or more objects in a surrounding environment of the charging apparatus, wherein the one or more sensors comprise at least one of an image sensor or a lidar; and
a controller electrically connected to the one or more sensors, wherein the controller is configured to control, based on data received from the one or more sensors, a driving operation of the plurality of wheels.

4. The charging apparatus of claim 1, wherein the robot arm further comprises:
a base;
a plurality of links; and
a coated conductor electrically connected to the charging cable, wherein the coated conductor runs along the base, the plurality of links, and the end effector to connect to the charging connector, and
wherein the robot arm is capable of multi-joint movement.

5. The charging apparatus of claim 4, further comprising:
a controller electrically connected to the robot arm,
wherein the controller is configured to control movement and position of the charging connector by controlling a motor in the robot arm.

6. The charging apparatus of claim 5, wherein the charging connector is connectable to a charging socket of a mobility apparatus,
wherein the charging connector comprises a positioning sensor for detecting a position of the charging socket, wherein the positioning sensor is mounted on the charging connector and electrically connected to the controller, and
wherein the controller is further configured to control the motor in the robot arm based on data received from the positioning sensor.

7. The charging apparatus of claim 6, wherein the positioning sensor is configured to acquire image data associated with the charging socket, and
wherein the controller is configured to:
detect, in the acquired image based on a deep learning model, the charging socket; and
output coordinates associated with the position of the charging socket.

8. The charging apparatus of claim 4, further comprising a cooling circuit disposed in the mobile robot and the robot arm and configured to dissipate heat generated by the coated conductor.

9. The charging apparatus of claim 8, wherein the cooling circuit comprises:
a refrigerant tank configured to store a refrigerant;
a pump configured to pressurize and circulate the refrigerant from the refrigerant tank;
a radiator configured to cool the refrigerant after a temperature of the refrigerant is raised; and
a refrigerant hose connecting the refrigerant tank, the pump, and the radiator for circulation of the refrigerant, and
wherein the refrigerant hose is disposed, in the robot arm, to run along the coated conductor.

10. The charging apparatus of claim 9, wherein the radiator comprises a cooling fan, and
wherein the cooling circuit further comprises a heater configured to control the temperature of the refrigerant.

11. The charging apparatus of claim 1, wherein the charging connector comprises a housing, and
wherein an edge of the housing is formed by chamfering to have a curved surface or an inclined surface.

12. The charging apparatus of claim 1, wherein the charging connector is connectable to a charging socket of a mobility apparatus, and
wherein the charging apparatus further comprises a gimbal interposed between the end effector and the charging connector to mitigate a spatial displacement between the charging connector and the charging socket.

13. The charging apparatus of claim 12, wherein the gimbal comprises:
a ball joint having a ball stud, wherein an end portion of the ball stud is fixedly connected to the end effector;
a plurality of springs disposed, between the end effector and the charging connector, at regular intervals from each other around the ball joint; and
a plurality of displacement sensors, wherein each of the plurality of displacement sensors is disposed in a corresponding spring of the plurality of springs and installed on the end effector to form a cantilever.

14. The charging apparatus of claim 13, wherein the mobile robot comprises a controller electrically connected to the robot arm,
wherein the plurality of displacement sensors are electrically connected to the controller, and
wherein the controller is configured to control, based on data received from the plurality of displacement sensors, movement of the robot arm.

15. The charging apparatus of claim 14, wherein the controller is configured to control the movement of the robot arm by:
determining, based on measurements by the plurality of displacement sensors, a plurality of distances between the charging connector and the end effector, wherein each of the plurality of distances is measured by a corresponding displacement sensor of the plurality of displacement sensors;
determining, based on a deviation among the plurality of distances between the charging connector and the end effector, an insertion angle of the charging connector and an angle adjustment amount; and
controlling, based on the determined angle adjustment amount, the movement of the robot arm to adjust a position of the end effector.

16. The charging apparatus of claim 1, further comprising an elevating platform installed on the mobile robot and configured to elevate or lower the robot arm relative to the mobile robot, wherein the elevating platform comprises:
a first platform on which the robot arm is mounted;
a second platform disposed on the mobile robot;
a plurality of scissor linkages disposed between the first platform and the second platform to connect the first platform to the second platform; and
a first motor mounted on the second platform and configured to move the plurality of scissor linkages.

17. The charging apparatus of claim 16, wherein the elevating platform further comprises a pair of link assemblies disposed at a predetermined distance from each other, wherein each of the pair of link assemblies comprises the plurality of scissor linkages, and wherein the pair of link assemblies are connected by a plurality of shafts that connect to hinges of the plurality of scissor linkages.

18. The charging apparatus of claim 17, further comprising:
a bearing block installed on one side of the second platform;
a nut provided on one of the plurality of shafts; and
a bolt shaft rotatably installed between the bearing block and the nut,
wherein the first motor is connected to the bolt shaft and configured to rotate the bolt shaft in a forward or reverse direction.

19. The charging apparatus of claim 16, wherein the second platform is mounted on at least one rail disposed on the mobile robot such that the second platform is slidable along the at least one rail, and
wherein the mobile robot comprises a second motor configured to cause the second platform to slide across the mobile robot.

20. A charging apparatus comprising:
a mobile robot capable of autonomous driving, wherein a charging cable is connected to one side of the mobile robot;
a robot arm installed on the mobile robot;
an elevating platform installed on the mobile robot and configured to elevate or lower the robot arm relative to the mobile robot; and
a charging connector mounted on an end of the robot arm and electrically connected to the charging cable, wherein an orientation of the charging connector is configured to be adjustable relative to the end of the robot arm.
